(19) United States
(12) Patent Application Publication
(10) Pub. No.: US 2010/0179877 A1
(43) Pub. Date: Jul. 15, 2010

(54) PROVIDING PROMOTIONAL DATA TO REGISTERED WIRELESS COMMUNICATION DEVICES

(75) Inventor: Fiona Lam, Pacific Pines (AU)

Correspondence Address: IBM CORPORATION;INTELLECTUAL PROPERTY LAW, 11501 BURNET ROAD, AUSTIN, TX, 78758, US

(73) Assignee: International Business Machines Corporation, Armonk, NY (US)

(21) Appl. No.: 12/354,038

(22) Filed: Jan. 15, 2009

(51) Int. Cl. G06Q 30/00; G01C 21/00; H04W 4/02

(52) U.S. Cl. 705/14.55; 701/300; 455/456.3; 705/14.58; 705/14.64

(57) ABSTRACT

Functionality can be implemented to transmit advertisements to customers who have registered to receive promotional messages from a business. Detecting wireless devices in the vicinity of the business, determining if the detected wireless device is registered to receive promotional messages, and transmitting the promotional messages to the detected wireless device can help businesses build customer loyalty, increase brand recognition, provide positive brand association against competitors, and receive repeat sales. Providing registered customers with additional options of rejecting incoming promotional messages or unsubscribing from the customer database can reduce the number of unsolicited messages transmitted.

### BACKGROUND

Embodiments of the inventive subject matter generally relate to the field of wireless communication, and more particularly, to techniques for providing promotional services to business customers using wireless communication devices.

Businesses typically maintain a customer database with customer contact information to keep track of past customers, provide advance notification of impending sales, and provide rewards to maintain their customer base and increase sales. Traditional methods of advertising include paper based methods (e.g., mailing brochures to customers) and Internet based methods (e.g., emailing online brochures, notifications of sales, etc). However, the businesses' attempts to reach out to a large number of people may be ineffective because of strong spam filters and may be considered annoying, intrusive, and an invasion of privacy.

### SUMMARY

Embodiments include a method comprising detecting the presence of a wireless device within transmission range of a wireless transmitting device. The wireless transmitting device is associated with a business. It is determined whether the detected wireless device is indicated in a database associated with the wireless transmitting device. Promotional messages are transmitted to the detected wireless device, if it is determined that the database indicates a transmission status that allows transmitting promotional messages of the business to the detected wireless device.

### BRIEF DESCRIPTION OF THE DRAWINGS

The present embodiments may be better understood, and numerous objects, features, and advantages made apparent to those skilled in the art by referencing the accompanying drawings.

FIG. 1 is an example conceptual diagram illustrating transmitting of promotional messages to registered wireless devices.

FIG. 2 is an example conceptual diagram depicting wireless devices that can receive promotional messages.

FIG. 3 is a flow diagram illustrating example operations for determining and transmitting promotional material to registered wireless devices

FIG. 4 is a flow diagram illustrating example operations for modifying wireless device registration.

FIG. 5 is an example block diagram configured to transmit promotional messages to registered wireless devices.

FIG. 6 is an example computer system configured to transmit promotional messages to registered wireless devices.

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. For instance, although the examples refer to promotional advertising messages; educational messages may also be transmitted. In some instances, well-known instruction instances, protocols, structures, and techniques have not been shown in detail in order not to obfuscate the description.

Marketing techniques that require customers to carry special portable devices to receive promotional messages from businesses, may be viewed as cumbersome. Proximity marketing techniques that transmit promotional messages to all customers, in the vicinity of the business, may be perceived as intrusive. Advertising techniques that target customers in or near the business only if the customers register to receive promotional messages are more likely to reach interested target customers and entice the customers into buying merchandise from the business. Customers may be more willing to register to receive promotional messages on their portable wireless devices. Customers may also be more likely to register with services that do not require the customers to provide personal information, other than a wireless phone number, do not require the customers to configure a number of settings, or carry around additional identity cards and/or devices. Providing registered customers with additional options of rejecting incoming promotional messages or unsubscribing from a customer database can reduce the number of unsolicited messages transmitted, thus complying with spam and privacy laws. After detecting a wireless device in the vicinity of the business, a server, for example, can determine whether the wireless device is registered to receive promotional messages. Transmitting the promotional messages to the registered, detected wireless device can help the business build customer loyalty, increase brand recognition, provide positive brand association against competitors, and receive repeat sales.

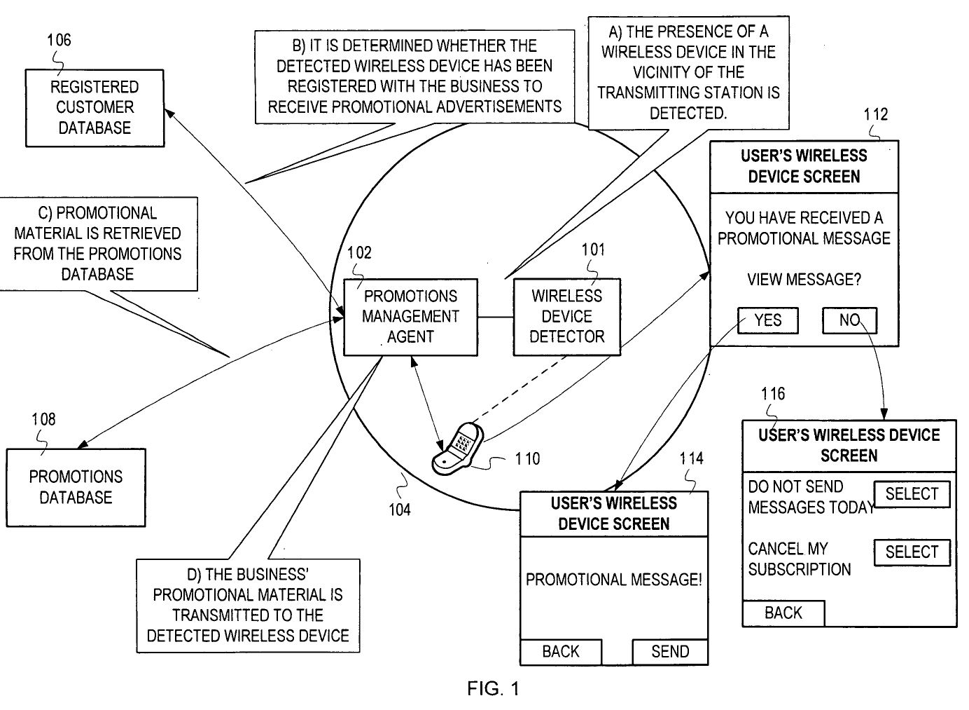

FIG. 1 is an example conceptual diagram illustrating transmitting of promotional messages to registered wireless devices. FIG. 1 depicts a wireless device detector 101 with a wireless radius (denoted by a circle) 104. The wireless device detector 101 is in communication with a promotions management agent 102. A client mobile phone 110 is within the wireless radius 104. Additionally, the promotions management agent 102 is in communication with a registered customer database 106 and a promotions database 108.

At stage A, the wireless device detector 101 detects the presence of the client mobile phone 110 in its wireless radius 104. Although depicted as a mobile phone, the detected device may be a pager, a laptop, a personal digital assistant (PDA), or any suitable wireless device. The wireless device detector 101 can determine any one of the wireless device's phone number, device identification number, etc.

At stage B, the promotions management agent 102 interfaces with the registered customer database 106 and determines whether the detected mobile phone 110 has registered with the business to receive promotional material. The registered customer database 106 may be stored locally as part of the promotions management agent 102 and may comprise device identifiers associated with wireless devices that have been registered at a local store. The registered customer database 106 may be a centralized database (e.g., for stores and businesses with branches all over the country or over the world). Having a centralized database may help a business target their registered customers irrespective of the customers' location. At stage B, the promotions management agent 102 determines that the mobile phone's identification number is indicated in the registered customer database 106. Therefore, the promotions management agent 102 determines that the promotional material should be transmitted to the mobile phone 110.

At stage C, the promotions management agent 102 interfaces with the promotions database 108, and retrieves promotional material from the promotions database 108. The promotional material can include notification of sales, notifications of arrival of a new product, coupons to reward customer loyalty, etc. The promotional material may be in the form of text (e.g., rich-text, plain text), images, audio, video, or any suitable digital format.

At stage D, the promotions management agent 102 transmits the retrieved promotional material to the customer's mobile phone 110. The promotions management agent 102 may transmit this promotional material using wireless communication protocols such as Bluetooth®, Wi-Fi®, Short Messaging Service (SMS), Multimedia Messaging Service (MMS), wireless application protocol (WAP), wireless communications transfer protocol (WCTP), etc. In some implementations, the promotions management agent 102 may also tailor the promotional messages according to the customer's requirements and/or the capabilities of the wireless device.

After the promotions management agent 102 transmits the promotional message, the customer is notified of an incoming promotional message and is given the option of viewing or rejecting the message as depicted by screen 112. If the customer accepts the incoming message, the promotional message is displayed on the customer's mobile phone screen, as depicted by screen 114. Alternately, if the customer rejects the incoming promotional message, screen 116 is displayed. On screen 116, the customer is given the option of opting out of promotional messages for the entire day or permanently unsubscribing from the registered customer database 108.

FIG. 1 is an example block diagram and should not be used to limit the scope of the embodiments. Although the promotions management agent 102 is depicted as transmitting promotional messages to the detected wireless device 110, in some implementations, the wireless device detector 101 could comprise functionality for receiving promotional messages from the promotions management agent 102 and transmitting the messages to the detected wireless device. In addition, the registered customer database 106 may also comprise a profile (e.g., age, gender, etc.) associated with registered customers to enable tailoring the promotional messages in accordance with the customer's requirements. Although depicted as a database, the registered customer database 106 can be any suitable information repository such as a spreadsheet, a hardware table, a text file, etc. In some implementations, a combination of two or more information repositories may be used. For example, a list of registered users and the wireless device identifiers associated with the registered users may be stored in a spreadsheet. Profile information associated with the list of registered users may be stored in a database. The promotions management agent 102 may access both the database and the spreadsheet to determine whether the detected user is registered with the business and tailor the promotional messages according to the profile information. As another example, the promotions management agent 102 may look up a first data and an index in one information repository and use the index to access a second data in a second information repository.

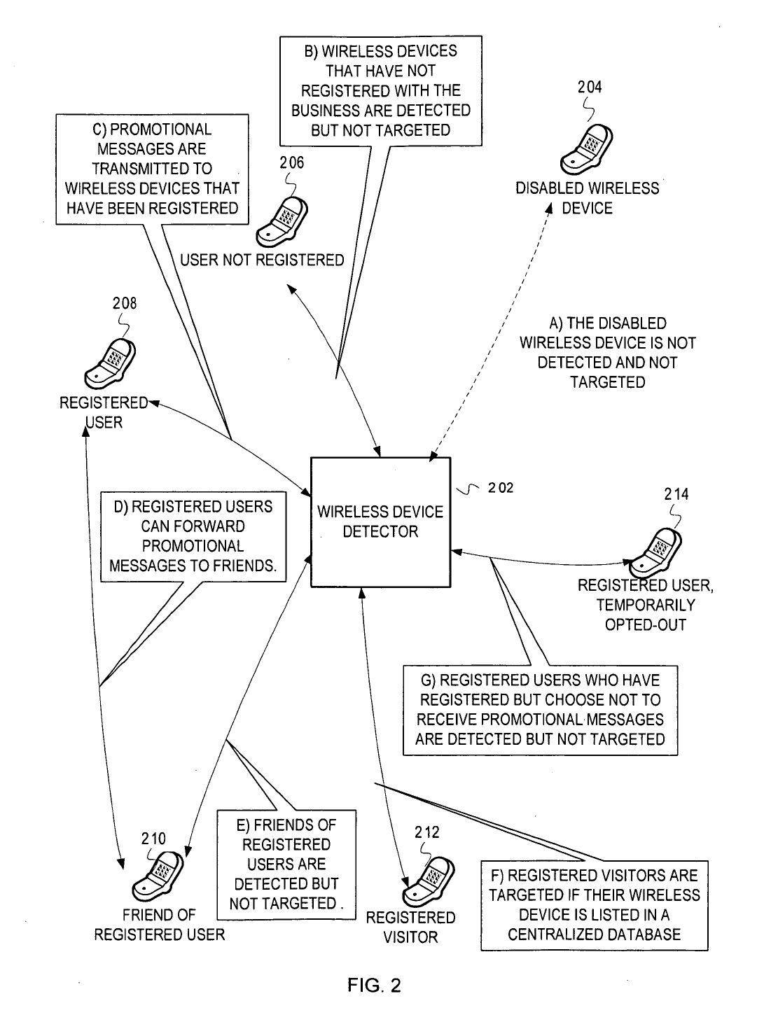

FIG. 2 is an example conceptual diagram depicting wireless devices that can receive promotional messages. FIG. 2 depicts a wireless device detector 202. The wireless device detector 202 is typically associated with a wireless range, such that the wireless device detector 202 detects any wireless device in the wireless range. FIG. 2 also depicts a plurality of wireless devices (e.g., mobile phones). A first wireless device 204 is disabled, a second wireless device 206 has not registered to receive promotional messages, while a third wireless device 208 has registered to receive promotional messages. A fourth wireless device 210 has not registered to receive promotional messages. The fourth wireless device 210 receives messages from wireless device 208. A fifth wireless device 212 is a registered visitor (e.g., registered to receive promotional messages at a different store location), while a sixth wireless device 214 has registered but has temporarily opted-out of receiving promotional messages.

At stage A, the wireless device detector 202 is unable to detect the first wireless device 204 because the wireless device 204 is disabled (e.g., the device is powered off). Therefore, promotional messages are not transmitted to the first wireless device 204.

At stage B, the wireless device detector 202 detects the second wireless device 206. The wireless device detector 202 determines the second wireless device's identification number and determines (e.g., by interfacing with a database) whether the second wireless device 206 is registered to receive promotional messages. The wireless device detector 202 does not transmit promotional messages to the second wireless device 206 because the wireless device 206 has not registered to receive the promotional messages.

At stage C, the wireless device detector 202 detects the third wireless device 208. The wireless device detector 208 records the third wireless device's identification number and determines that the third wireless device 208 has been registered to receive promotional messages. Therefore, promotional messages are transmitted to the third wireless device 208. At stage D, the third wireless device 208 transmits the received promotional messages to the fourth wireless device 210. At stage E, the wireless device detector 202 detects the fourth wireless device 210. However, because the fourth wireless device 210 is not registered to receive promotional messages, the messages are not transmitted to the fourth wireless device 210. Thus, the fourth wireless device 210 may receive promotional messages from a friend (e.g., wireless device 208). However, the fourth wireless device 210 does not receive promotional messages from the business unless the wireless device 210 registers to receive the promotional messages.

At stage F, the wireless device detector 202 detects a fifth wireless device 212. The fifth wireless device 212 is a registered visitor. In other words, the fifth wireless device 212 is registered to receive promotional messages at a location different from the location of the wireless device detector 202. If a centralized list of registered wireless devices is maintained, the wireless device detector 202 can determine that the fifth wireless device 212 has been registered (at another store) to receive promotional messages. The wireless device detector 202 can accordingly transmit the promotional messages to the fifth wireless device 212. However, if a local database of registered wireless devices (e.g., list of wireless devices that have been registered at a particular location) is maintained, the fifth wireless device 212 will not be listed as a registered device. Therefore, the promotional messages will not be transmitted to the fifth wireless device 212.

At stage G, the wireless device detector 202 detects a sixth wireless device 214. Customers may choose to temporarily block promotional messages. A flag indicating that the customer has opted out of receiving messages, either temporarily or permanently, may be incorporated as part of the registered customer database. Because the sixth wireless device 214 has temporarily opted-out, the promotional messages are not transmitted to the wireless device 214.

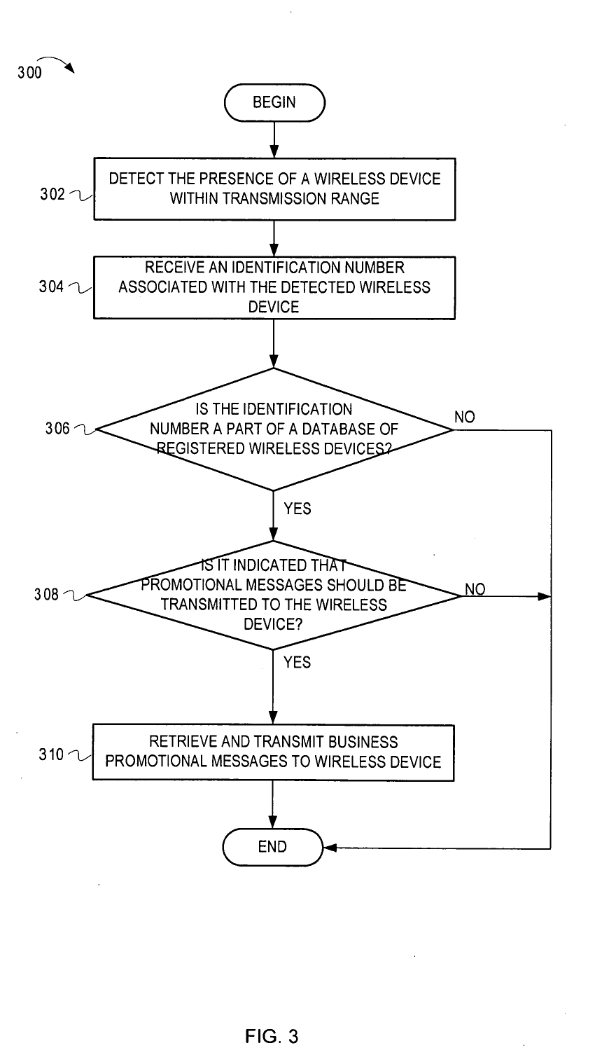

FIG. 3 is a flow diagram illustrating example operations for determining and transmitting promotional material to registered wireless devices. The flow 300 begins at block 302.

At block 302, the presence of a wireless device within a transmission range is detected. Examples of wireless devices include mobile phones, pagers, Bluetooth devices, laptops, etc. The presence of the wireless device may be detected, for example, by a wireless device detector. The wireless device detector can continuously scan a range of pre-defined frequencies and detect the presence of a wireless device within a pre-defined transmission range. In some implementations, the wireless device detector can transmit a global polling message and request that all wireless devices in the vicinity (i.e., devices that receive the polling message) respond by transmitting their unique identification number. The flow continues at block 304.

At block 304, after the presence of the wireless device is detected, an identification number associated with the detected wireless device is received. The received identification number can comprise any one or more of the wireless device's phone number and device serial number. For example, a mobile phone may transmit any one of a mobile identification number (MIN), an electronic serial number (ESN), or a system identification code (SID). In some implementations, the wireless device may also transmit, in response to query from the wireless device detector, a message format compatible with the detected wireless device. The flow continues at block 306.

At block 306, it is determined whether the received identification number is indicated in a database of registered wireless devices. The database of registered wireless devices may be associated with a business or a store. The database of registered wireless devices may be a centralized database or a localized database. A centralized database may help the business, target customers from different parts of the country who have registered at different locations. A localized database may be more suited in helping small-scale businesses target their local customers. In some implementations, the received identification number may be indicated in any suitable information repository such as a spreadsheet, a text file, a hardware table, etc. If it is determined that the detected wireless device is indicated in the database, the flow continues at block 308. Otherwise, the flow ends.

At block 308, it is determined whether it is indicated that promotional messages should be transmitted to the wireless device. Customers register their wireless devices to receive promotional messages from a business. Customers also have the option of temporarily blocking promotional messages from the business. It may be indicated (e.g., in the database of registered wireless devices) whether the promotional messages should be transmitted to the wireless devices. For example, the database of registered wireless devices may include a “message receiving status”, associated with each registered wireless device, which may be set to “transmit” or “ignore”. In some implementations, customers may have an option of selecting a number of days during which promotional messages should not be transmitted. For example, a customer may choose not to receive promotional messages for a day, a second customer may choose to receive messages during holiday seasons, while a third customer may choose to permanently stop receiving the promotional messages. The database indicating whether promotional messages should be transmitted to the wireless devices may be automatically updated to reflect the “message receiving status” associated with the wireless device. For example, the “message receiving status” associated with the second customer may be set to “ignore” for one week to indicate the customer does not wish to receive promotional messages. The “message receiving status” associated with the second customer may automatically be set to “transmit” after the one week indicating that promotional messages should now be transmitted to the customer's wireless device. If it is determined that the detected wireless device is opted-in to receive promotional messages, the flow continues at block 308. Otherwise, the flow ends.

At block 310, promotional messages are retrieved (e.g., from a promotional messages database) and transmitted to the wireless device. The retrieved promotional messages may be tailored according to a target customer (e.g., the customer's age, gender, etc). The retrieved promotional messages may also be tailored depending on the capabilities of the wireless device. For example, promotional messages with multimedia content may not be transmitted to wireless devices without MMS capabilities. In some implementations, after the promotional messages are retrieved and tailored, it may be determined, e.g., by a wireless device detector, whether the wireless device is still within transmission range. The promotional messages may be transmitted using different communication protocols depending on whether the wireless device is still within transmission range for a particular communication protocol. For example, if the wireless device is within transmission range, promotional messages may be transmitted using Bluetooth. If the wireless device is no longer in transmission range by the time the promotion messages are ready to be transmitted, the communication protocol may be switched from a wireless transmission protocol (e.g., Bluetooth) to SMS or MMS. From block 310, the flow ends.

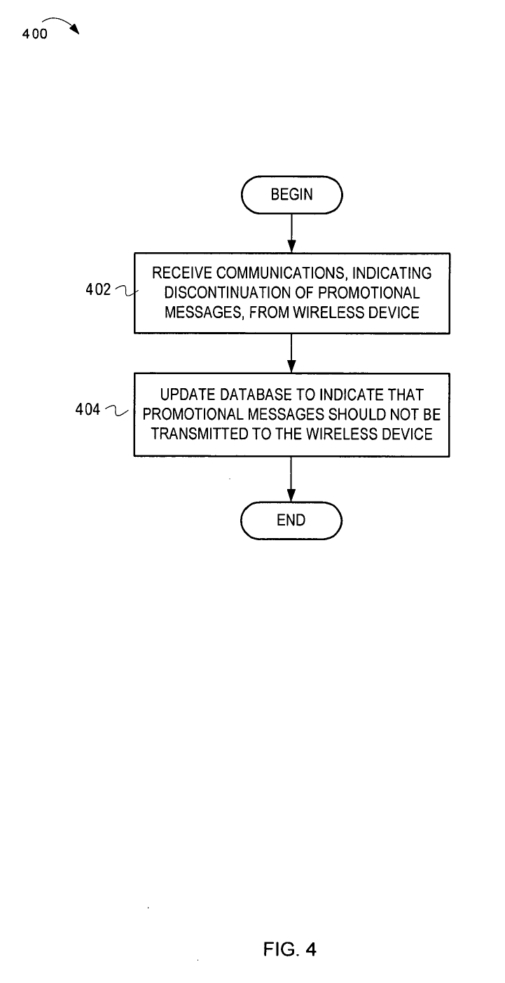

FIG. 4 is a flow diagram illustrating example operations for modifying wireless device registration. The flow 400 begins at block 402.

At block 402, communications, indicating a discontinuation of promotional messages, are received from a wireless device. The communications sent by the wireless device may comprise the wireless device's identification number along with a flag indicating that promotional messages should no longer be transmitted. The communications received from the wireless device can indicate a number of days for which the customer does not wish to receive the promotional messages. The customer may also indicate whether the customer wishes to permanently stop receiving the promotional messages. The flow continues at block 404.

At block 404, a database is updated, indicating that promotional messages should not be transmitted to the wireless device. In the database, a flag associated with the wireless device's identification number may be set to indicate that promotional messages should not be transmitted. The database may also record the number of days for which the customer does not want to receive promotional messages. From block 404, the flow ends.

It should be understood that the depicted flow diagrams (FIGS. 3-4) are examples meant to aid in understanding embodiments and should not be used to limit embodiments or limit scope of the claims. Embodiments may perform additional operations, fewer operations, operations in a different order, operations in parallel, and some operations differently. For example, communications received from the wireless device may indicate that the customer wishes to view the promotional messages. It may also be indicated whether the customer wishes to receive similar messages in the future.

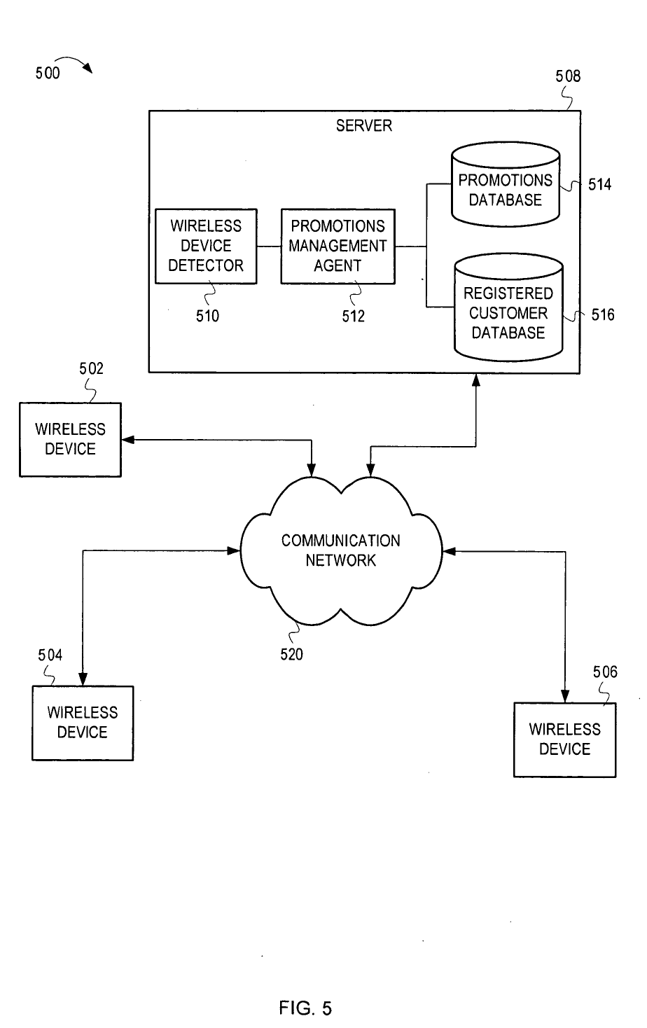

FIG. 5 is an example block diagram configured to transmit promotional messages to registered wireless devices. As shown in FIG. 5, the system 500 comprises a server 508 and wireless devices 502, 504 and 506. The server 508 is typically associated with a store or a business. The server 508 comprises a promotions management agent 512 coupled with a wireless device detector 510, a promotions database 514 and a registered customer database 516. The promotions database 514 comprises advertisements (e.g., notification of sales, notifications of new merchandise in the store, customer coupons, etc.) and may be in the form of text, images, audio, and video. The registered customer database 516 comprises a list of registered wireless devices. The registered customer database 516 may include names of registered customers, wireless device identification numbers, and a flag indicating whether the customer wants to receive promotional messages.

The wireless device detector 510 detects wireless devices within the wireless device detector's transmission range. The wireless device detector 510 also determines and records the wireless device's identification number. The wireless device detector 510 may also query the wireless device (e.g., 502) to determine one or more message formats that the wireless device is configured to receive. The promotions management agent 512 determines whether the received wireless device identification number is listed in the registered customer database 516. In other words, the promotions management agent 512 determines whether the wireless device is registered to receive promotional messages. The promotions management agent 512 does not transmit promotional messages to wireless devices that are not registered to receive the promotional messages. If the promotions management agent 512 determines that the detected wireless device is listed in the registered customer database 516, the promotions management agent 512 retrieves promotional messages from the promotions database 514. The promotions management agent 512 may tailor the promotional messages to suit the customer's requirements or may transmit the promotional messages without any modifications to the wireless device. Customers may also unsubscribe, via their wireless devices, to stop receiving promotional messages.

Although depicted as part of the server 508, the wireless device detector 510 may not be part of the server 508. The wireless device detector 510 may be embodied as a stand-alone unit configured to detect the presence of a wireless device. On detecting the wireless device, the wireless device detector may communicate, using wireless or wired communications, with a back-end server comprising the promotions management agent.

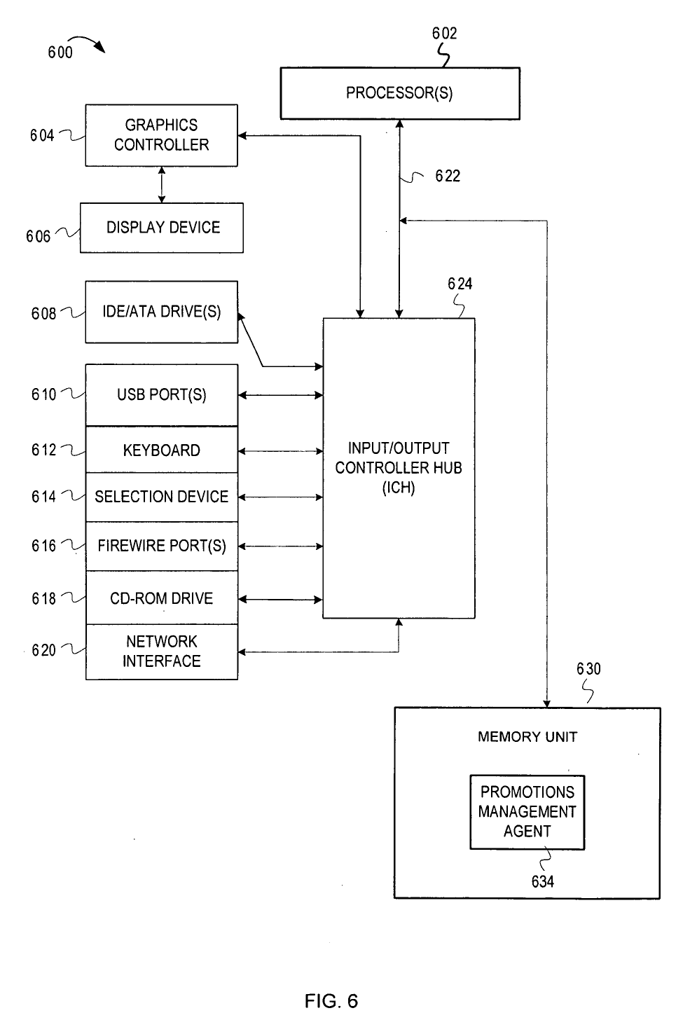

The server 508 and the wireless devices 502, 504, and 506 are connected to a communication network 520. The communication network 520 can include any technology suitable for passing communication between the clients and servers (e.g., Ethernet, 802.11n, SONET, etc.). Moreover, the communication network 520 can be part of other networks, such as cellular telephone networks, public-switched telephone networks (PSTN), cable television networks, etc. Additionally, the server 508 and wireless devices (e.g., 504) can be any suitable computing devices capable of executing software in accordance with the embodiments described herein. For example, the wireless devices can be any one of mobile phones, pagers, personal digital assistants, laptops, etc. The server and/or the wireless devices may be embodied as an example computer system illustrated in FIG. 6.

FIG. 6 is an example computer system configured to transmit promotional messages to registered wireless devices. The computer system 600 includes a processor 602. The processor 602 is connected to an input/output controller hub 624 (ICH), also known as a south bridge, via a bus 622 (e.g., PCI, ISA, PCI-Express, HyperTransport, etc). A memory unit 630 interfaces with the processor 602 and the ICH 624. The main memory unit 630 can include any suitable random access memory (RAM), such as static RAM, dynamic RAM, synchronous dynamic RAM, extended data output RAM, etc.

The memory unit 630 comprises a promotions management unit 634. The promotions management unit 634 embodies functionality for determining whether a detected wireless device is registered to receive promotional messages, retrieving the promotional messages, and transmitting the promotional messages to the detected wireless device. The promotions management unit 634 may also configure the promotional messages according to the data corresponding to the owner of the detected wireless device and/or the capabilities of the detected wireless device.

The ICH 624 connects and controls peripheral devices. In FIG. 6, the ICH 624 is connected to IDE/ATA drives 608 (used to connect external storage devices) and to universal serial bus (USB) ports 610. The ICH 624 may also be connected to a keyboard 612, a selection device 614, firewire ports 616 (for use with video equipment), CD-ROM drive 618, and a network interface 620. The ICH 624 can also be connected to a graphics controller 604. The graphics controller is connected to a display device 606 (e.g., monitor). In some embodiments, the computer system 600 can include additional devices and/or more than one of each component shown in FIG. 6 (e.g., video cards, audio cards, peripheral devices, etc.). For example, in some instances, the computer system 600 may include multiple processors, multiple cores, multiple external CPU's. In other instances, components may even be integrated or subdivided.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

While the embodiments are described with reference to various implementations and exploitations, it will be understood that these embodiments are illustrative and that the scope of the inventive subject matter is not limited to them. In general, techniques for providing promotional services to business customers using wireless communication devices as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A computer-implemented method comprising:
detecting the presence of a wireless device within transmission range of a wireless transmitting device, wherein the wireless transmitting device is associated with a business;
determining that the detected wireless device is indicated in an information repository associated with the wireless transmitting device;
determining that the information repository indicates a transmission status that allows transmitting promotional messages of the business to the wireless device; and
transmitting the promotional messages to the detected wireless device.

2. The method of claim 1, wherein the information repository is one or more of a database, a spreadsheet, a hardware table, and a text file.

3. The method of claim 1, wherein the detecting the presence of the wireless device within transmission range of the wireless transmitting device comprises detecting any one of the wireless device's phone number, the wireless device's identification number, the wireless device's media access control address, and the wireless device's hardware address.

4. The method of claim 1, wherein the promotional messages are transmitted to the detected wireless device using a communication protocol comprising any one of Bluetooth, Wi-Fi, Short messaging service, multimedia messaging service, wireless application protocols, and wireless communications transfer protocol.

5. The method of claim 1, wherein the detected wireless device is any one of a mobile phone, a personal digital assistant, a pager, and a laptop.

6. The method of claim 1, wherein the promotional messages are in any one or more of a plain text format, a rich text format, an audio format, a video format, and an image format.

7. The method of claim 1 further comprising determining receiving capabilities of the detected wireless device.

8. The method of claim 7, further comprising:
selecting a communication protocol based at least in part on the determined receiving capabilities of the detected wireless device and a distance between the detected wireless device and the wireless transmitting device; and
transmitting the promotional messages to the detected wireless device using the selected communication protocol.

9. The method of claim 1, further comprising:
retrieving a profile of a customer associated with the detected wireless device; and
customizing the promotional messages based on the profile of the customer.

10. A computer-implemented method comprising:
detecting the presence of a wireless device within transmission range of a wireless transmitting device, wherein the wireless transmitting device is associated with a business;
determining that the detected wireless device is indicated in an information repository associated with the wireless transmitting device, wherein the information repository comprises a list of wireless devices registered with the business;
receiving a message from the detected wireless device, wherein the message indicates that promotional messages of the business should no longer be transmitted to the wireless device; and
modifying the information repository associated with the wireless transmitting device to indicate a transmission status that prevents transmitting promotional messages of the business to the wireless device.

11. The method of claim 10, wherein the information repository is one or more of a database, a spreadsheet, a hardware table, and a text file.

12. The method of claim 10, wherein the list of wireless devices registered with the business is stored in any one of a localized and a centralized information repository.

13. The method of claim 10, wherein the promotional messages are any one or more of notifications of sales, details about new products, coupons for products sold by the business, and incentives to reward customers.

14. A computer program product for transmitting promotional messages to registered wireless devices, the computer program product comprising:
a computer usable medium having computer usable program code embodied therewith, the computer usable program code comprising:
computer usable program code configured to:
detect the presence of a wireless device within transmission range of a wireless transmitting device, wherein the wireless transmitting device is associated with a business;
determine that the detected wireless device is indicated in an information repository associated with the wireless transmitting device;
determine that the information repository indicates a transmission status that allows transmitting promotional messages of the business to the wireless device; and
transmit the promotional messages to the detected wireless device.

15. The computer program product of claim 14, wherein the information repository is one or more of a database, a spreadsheet, a hardware table, and a text file.

16. The computer program product of claim 14, wherein said computer usable program code being configured to detect the presence of the wireless device within transmission range of the wireless transmitting device comprises the computer usable program code being configured to detect any one of the wireless device's phone number, the wireless device's identification number, the wireless device's media access control address, and the wireless device's hardware address.

17. The computer program product of claim 14, wherein the promotional messages are transmitted to the detected wireless device using a communication protocol comprising any one of Bluetooth, Wi-Fi, Short messaging service, multimedia messaging service, wireless application protocols, and wireless communications transfer protocol.

18. The computer program product of claim 14, wherein the computer usable program code is further configured to determine receiving capabilities of the detected wireless device.

19. The computer program product of claim 18, wherein the computer usable program code is further configured to:
select a communication protocol based at least in part on the determined receiving capabilities of the detected wireless device and a distance between the detected wireless device and the wireless transmitting device; and
transmit the promotional messages to the detected wireless device using the selected communication.

20. The computer program product of claim 19, wherein the computer usable program code is further configured to:
retrieve a profile of a customer associated with the detected wireless device; and
customize the promotional messages based on the profile of the customer.

21. An apparatus comprising:
a set of one or more processors;
a memory unit coupled with the set of one or more processors
a registered customer database comprising a list of one or more of phone numbers and device serial numbers associated with registered wireless devices; and
a promotions management agent configured to
detect the presence of a wireless device within transmission range of a wireless transmitting device, wherein the wireless transmitting device is associated with a business;
determine that the detected wireless device is indicated in an information repository associated with the wireless transmitting device;
determine that the information repository indicates a transmission status that allows transmitting promotional messages of the business to the wireless device; and
transmit the promotional messages to the detected wireless device.

22. The apparatus of claim 21, wherein the information repository is one or more of a database, a spreadsheet, a hardware table, and a text file.

23. The apparatus of claim 21, wherein the promotions management agent comprises one or more machine-readable media.
